(19) United States
(12) Patent Application Publication
(10) Pub. No.: US 2013/0124606 A1
(43) Pub. Date: May 16, 2013

(54) AUTOMATIC PERSONALIZATION OF DOWNLOADABLE MOBILE APPS

(71) Applicants: G. Gregory Carpenter, Laguna Beach, CA (US); Timothy L. Kay, Los Altos, CA (US)

(72) Inventors: G. Gregory Carpenter, Laguna Beach, CA (US); Timothy L. Kay, Los Altos, CA (US)

(73) Assignee: Boopsie, Inc., Laguna Beach, CA (US)

(21) Appl. No.: 13/295,748

(22) Filed: Nov. 14, 2011

(51) Int. Cl. G06F 15/16

(52) U.S. Cl. 709/203

(57) ABSTRACT

The present invention greatly simplifies the process of downloading and personalizing a mobile app by employing a unique code or “User ID” that associates the user with the mobile app. This User ID enables the mobile app to personalize itself automatically—i.e., without requiring the user to enter login information. To overcome the obstacle of providing the mobile app with access to the User ID, the invention existing web browser functionality is leveraged by employing a “cookie” into which the User ID is stored, and from which it is retrieved by an app server after the mobile app has been downloaded and initially launched by the user, thereby enabling the app server to provide the user with a personalized experience automatically. The app server sends the User ID to the mobile app, which stores it to enable a personalized experience whenever the user subsequently invokes the mobile app.

### BACKGROUND

A. Field of Art

This application relates generally to mobile apps, and in particular to the automatic personalization of such apps after they are downloaded onto mobile devices.

B. Description of Related Art

As smartphones and other mobile devices have begun to penetrate the mass market, there has been a dramatic increase in the availability of mobile apps (applications) for such devices. These apps run the gamut of functionality, including games, utilities, productivity apps (such as spreadsheets and word processors), and virtually any other product category found on desktop computers, in addition to location-based and other mobile-specific applications.

Third-party software developers can create apps to run on mobile device operating systems, such as Apple's iOS for iPhone and iPad devices, Google's Android OS for Android phone and tablet devices, and RIM's Blackberry OS for Blackberry phone and tablet devices (among others). Although apps can sometimes be purchased and downloaded onto mobile devices from third-party websites (“ad hoc” downloads), it is the availability of OS-specific “App Stores” in particular (such as Apple's App Store, the Android Market and Blackberry App World) that has spurred the creation of over one million apps and billions of app downloads in just over three years.

With the recent advent of “cloud computing,” the availability of “connected” apps that communicate with external servers and other devices is also increasing at an exponential pace. Because downloadable apps are typically packaged so as to prevent tampering, after which they are inspected and approved by App Stores, these apps cannot be personalized until after they are downloaded onto mobile devices.

In most cases, connected apps require (or at least permit) users to login in order to facilitate a personalized experience. For example, a Netflix user with an existing account (e.g., for streaming movies to a desktop PC or receiving rented DVDs by mail) might download the Netflix mobile app to his mobile phone to enable streaming of movies to his phone from his “instant queue.” Upon initially launching that app, however, the user is required to enter login info (e.g., name and password) before the app is “personalized” (e.g., to display the titles and descriptions of movies in his “instant queue”). The app typically stores this login information in persistent storage on the user's device for use during subsequent app launches.

While this one-time personalization process might not appear on the surface to be a significant inconvenience, a reduction in the number of steps required to download and personalize an app before it can be used effectively may well result in dramatic increases in the number of downloads and overall usage of that app. As users create accounts with a wide variety of service providers, and download apps onto multiple devices, and even share accounts among multiple family members, these obstacles quickly begin to mount.

Moreover, when services are provided through intermediaries, often to less “tech-savvy” users, the need for a simplified download and personalization process becomes even more apparent. Consider, for example, a residential real estate brokerage that provides a mobile app for use by its agents and their clients. The app might provide a personalized experience to each “home buyer” client with respect to that client's agent (e.g., showing each client information regarding only those homes in which that client is or might be interested). Yet, the agent must not only communicate to each client the process for locating and downloading the app, but must also provide login instructions to enable the user to personalize the app when it is first launched. Even though the agent possesses all of the required information, and can even create the accounts for each client, he must still require his clients to plod through a tedious download and personalization process. This “barrier to entry” is often enough to prevent many clients from ever downloading and using the app, and obtaining the benefits of the personalized experience—a “lose-lose” situation for the brokerage, their agents and their clients.

### SUMMARY

To address the obstacles described above, the present invention greatly simplifies the process of downloading and personalizing a mobile app by employing a unique code or “User ID” that associates the user with the mobile app. This User ID enables the mobile app to personalize itself automatically—i.e., without requiring the user to enter login information.

However, the mobile app must somehow obtain access to this User ID in order to effect personalization. As will be discussed in greater detail below, one of the chief obstacles to automatic personalization is the inability (on most mobile devices) of one app to access information stored by another app. By leveraging the existing functionality of web browsers built into most smartphones and mobile devices, a unique code or “User ID” (that associates the user with the mobile app) is stored and retrieved from a “cookie” in the web browser's storage area on the user's mobile device. The User ID is stored during the process of downloading the mobile app, and is retrieved when the mobile app is initially launched by the user.

In one embodiment, users need only “click 3 times” to download and personalize a mobile app: (1) clicking an “access” link, in response to a message (e.g., text or email) received on the user's mobile device—in order to access an external App Service that instructs the web browser on the device to store the User ID, and then redirects the user to the relevant location within the appropriate App Store); (2) clicking a “download” link that authorizes the App Store to download the mobile app; and (3) clicking the mobile app “icon” to launch the mobile app for the first time, whereupon it accesses the App Service, which retrieves the User ID and provides it to the mobile app, which then automatically personalizes itself (without ever requiring the user to enter login information).

As will be explained in greater detail below, the present invention can be employed not only on mobile devices, such as smartphones and tablets, but also on televisions, set-top boxes and Blu-ray players (e.g., to automatically personalize “smart apps” built into such devices), as well as virtually any device capable of storing and retrieving a User ID that associates a particular user with a particular app. Moreover, the developer of the operating system for a device could implement this invention by providing a mechanism for storing a User ID on the device, and enabling a mobile app on the device to retrieve that User ID. Other embodiments of the present invention will become apparent from the detailed description below.

### BRIEF DESCRIPTION OF DRAWINGS

FIG. 1 is a block diagram illustrating one embodiment of an architecture of the present invention, in which mobile apps can be downloaded to mobile devices and personalized automatically.

FIG. 2 is a flowchart of an existing process by which a user downloads a mobile app and manually personalizes it by entering login information into the app upon its initial launch.

FIG. 3 is a flowchart of one embodiment of a process of the present invention by which a user downloads a mobile app, which automatically personalizes itself upon its initial launch.

FIG. 4 is a more detailed flowchart of the step of the process illustrated in FIG. 3 in which the mobile app automatically personalizes itself upon its initial launch.

### DETAILED DESCRIPTION

### A. General Architecture

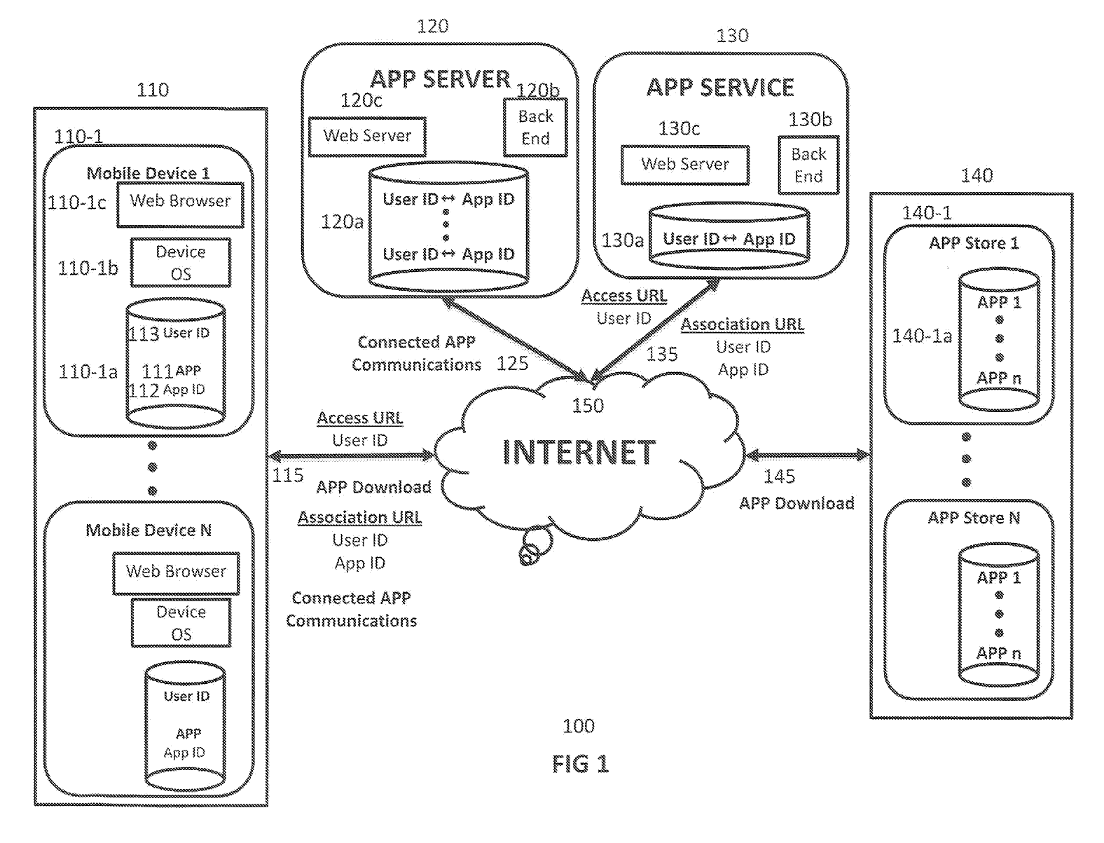

FIG. 1 illustrates one embodiment of an architecture of the present invention, in which devices communicate via the Internet 150. Client mobile devices 110 include smartphones, tablets and virtually any other type of mobile device, and could even include non-mobile devices, such as televisions, set-top boxes, Blu-ray players and other devices capable of running apps, such as the “smart apps” found on many recent home entertainment devices (Netflix, YouTube, Amazon, Pandora, etc.).

Mobile device 110-1 represents, in this embodiment, a smartphone with a mobile operating system 110-1a capable of running mobile apps, such as app 111 (and web browser 110-1c) and storing data in database 110-1b. Such data can include the code for mobile apps themselves, along with data stored by each mobile app. It should be noted that most existing mobile operating systems do not permit the data stored by one mobile app to be accessed by other mobile apps.

In one embodiment, mobile app 111 running on smartphone 110-1 stores an “App ID” 112 in database 110-1a that uniquely identifies the particular instance of that mobile app 111 running on this particular device 110-1. The same mobile app running on another mobile device (even if owned by the same user) would store a different App ID. As will be discussed in greater detail below, a unique App ID enables the provider of a mobile app to track the usage of each instance of the app (e.g., for personalization services such as distinguishing among different models of smartphones).

Smartphone 110-1 also stores a unique User ID 113 that uniquely associates the user of smartphone 110-1 with mobile app 111. In one embodiment, this User ID is cryptographically secure (i.e., not easily discernible) so that it can be communicated among devices over the Internet. If the same user had multiple different mobile (or non-mobile) devices, the same User ID could be employed. For example, if a Netflix account (including login info) was shared by a family, then each family member might utilize the same User ID to associate that account with the Netflix mobile app. In other embodiments, the User ID could vary per person, or even by device (and could even change over time for added security).

In the embodiment illustrated in FIG. 1, the provider of mobile app 111 maintains an App Server 120 that communicates with mobile app 111, which in this embodiment is a “connected” app. App Server 120 utilizes Web Server 120-c initially to create the user's account and personalized profile, as will be explained in greater detail below. It also employs Back End software 120-b to communicate with mobile app 111 and provide each user with a personalized experience. It stores information in database 120-a, including User ID 113 and (optionally) App ID 112, which enables it to associate the user of smartphone 110-1 with a particular instance of its mobile app 111. The use of this data by App Server 120 will be discussed in greater detail below with respect to the process by which mobile app 111 is downloaded by users and automatically personalized when initially launched.

In the embodiment illustrated in FIG. 1, the provider of mobile app 111 employs a separate App Service 130 to perform generic or undifferentiated functionality that is common to mobile apps provided by other providers. For example, mobile app 111 is characterized by particular features (such as the Netflix app's streaming video capabilities), and is personalized for each user (e.g., by providing each user with access to his own list of selected movies). Such features are particular to mobile app 111, and not found on other mobile apps, such as a game or calculator app. Yet, certain generic functions are common to many apps, such as the need to be downloaded from an App Store 140 (in this embodiment a particular App Store 140-1 associated with a particular mobile OS 110-1b, which stores mobile app 111 in database 140-1a) and the need to be personalized with each user's login info (or, in this embodiment, User ID 113).

It should be noted that, in other embodiments, the functions performed by App Service 130 could be performed by App Server 120 without departing from the spirit of the present invention. Moreover, App Server 120 could be managed by the provider of mobile app 111, or could be a generalized service utilized by many different mobile app providers. In the latter case, App Service 130 needs only the User ID information that associates each user with a particular mobile app, contact information for each user's mobile device(s), and the location of each mobile app in each relevant App Store 140. It does not need any other information about the internal functionality of the mobile apps offered by each of its provider customers.

App Service 130 stores user-specific information (such as User ID 113 and, in some embodiments, associated App ID 112) in database 130a. It utilizes Back End software 130b and Web Server 130c to provide generic services (discussed below) regarding the downloading and automatic personalization of mobile app 111 (and other mobile apps) on smartphone 110-1 (and on other mobile devices).

As will be explained in greater detail below, App Server 120 ultimately will provide a personalized experience to the user of smartphone 110-1. Communications between the two (via Internet 150) will include “Connected APP Communications” to/from smartphone 110-1 (via connection 115) and to/from App Server 120 (via connection 125). Mobile app 111 (stored in database 140-1a of Apple Store 140-1) must of course first be downloaded from App Store 140-1 (via connection 145) to smartphone 110-1 (via connection 115) and stored in database 110-1a. This download will be facilitated by an Access URL (containing User ID 113) provided by App Service 130 (via connection 135) to smartphone 110-1 (via connection 115). After the user downloads mobile app 111 and initially launches the app, mobile app 111 will, with the assistance of Web Browser 110-1c and Web Server 130c (within App Service 130), employ an Association URL (containing User ID 113 and optionally App ID 112) to retrieve User ID 113 from database 110-1a and provide it (via connection 135) to mobile app 111 (via connection 115).

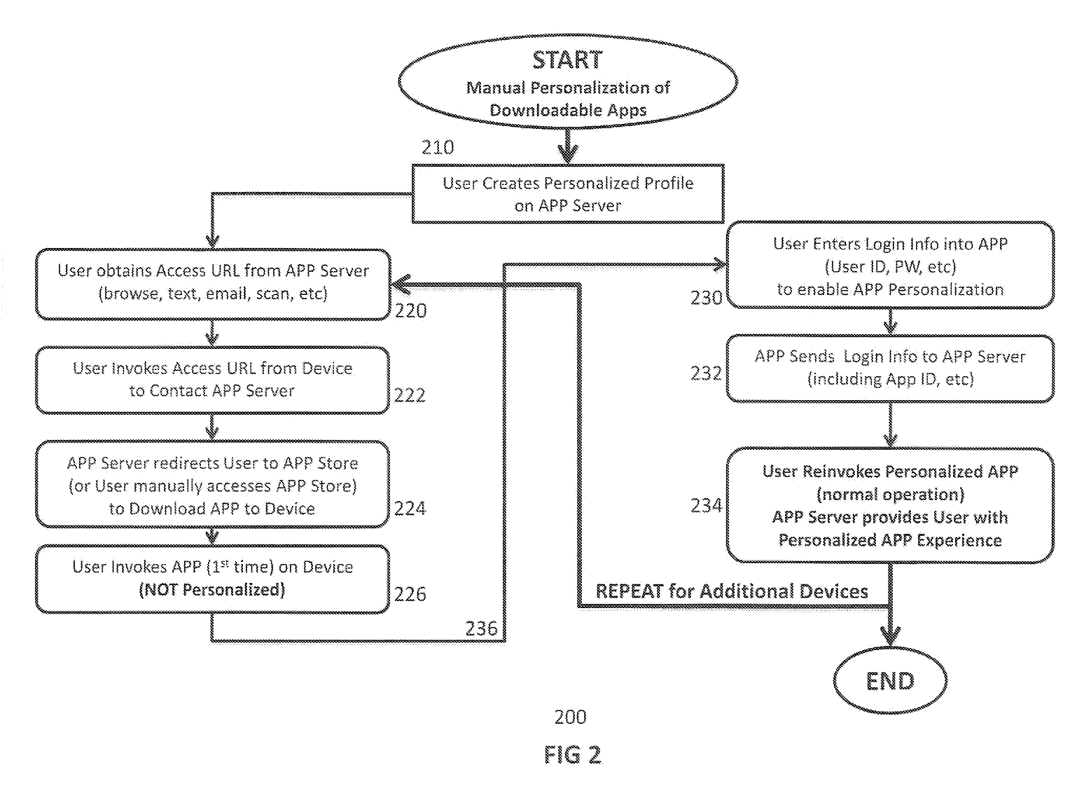

The details steps of this simplified download and automatic personalization process will be explained below, after first introducing and contrasting the existing manual “user-initiated” personalization process, illustrated in FIG. 2.

### B. Manual App Personalization Process

Turning to FIG. 2, manual process 200 begins at step 210, with the user creating a personalized profile on App Server 120. This step typically is performed from a desktop PC (and a standard web browser accessing web server 130c via a standard URL (such as www.netflix.com). A user could also utilize mobile web browser 110-1c (or a web browser from virtually any other device) to perform this function. The user's account could also be created by a third party, over the telephone or by many other alternative means.

Regardless of how the user's account and personalized profile is created, App Server 120 proceeds in step 220 to provide to the user's mobile device (such as smartphone 110-1) an Access URL containing a link to the relevant App Store (such as App Store 140-1) so that the user can download the mobile app (e.g., mobile app 111). It should be noted that this “Access URL” does not include any form of User ID (as does the present invention). It is simply a convenience to provide a “deep link” into the relevant page of an App Store to simplify the user's process of downloading the relevant mobile app.

It should also be noted that many providers do not provide this “deep link” or any link at all. In many case, users are required to search for the relevant App Store, locate the relevant mobile app, and initiate the download process (from their mobile device or desktop computer, which can then by synced to their mobile device(s)). It is far more convenient, however, to send this Access URL to the user's mobile device (e.g., via a text message, email or other means, such as a barcode or other scan).

Having received the Access URL on his mobile device, a user typically clicks on that Access URL in step 222 (often directly from an email or text messaging app), which invokes the device's web browser and accesses the web server on the App Server (such as Web Server 120c). The App Server then redirects the user in step 224 to the relevant “deep link” at the relevant App Store, where the user can then download the mobile app onto his mobile device. In many (though not all) cases, the mobile web browser will provide sufficient information in the link headers to enable the web server to determine the user's device type (e.g., an iPhone or an Android phone, and perhaps even the relevant model) and direct the user to the appropriate App Store. If such information is not provided, the web server can display a preliminary web page on the user's device, and ask the user to select from among various choices. In any case, the user is ultimately directed to the appropriate page in the relevant App Store (or finds the page manually) and downloads the mobile app.

Turning to step 226, the user launches the mobile app for the first time, and is presented with a non-personalized experience—i.e., a mobile app that does not “recognize” the user who initially launched the app. It should be noted that App Stores are currently just delivery mechanisms for providing users with (non-personalized) mobile apps. An App Store could employ aspects of the present invention to provide automatic personalization services (as described below), but they do not currently provide such capabilities.

Turning to step 230, the non-personalized mobile app then must ask the user to enter login information in order to manually personalize the app. Users will typically be asked to enter a user name and password, or other authenticating information. In some cases, the mobile app can personalize itself without needing any information from the App Server (e.g., simply configuring itself in accordance with the user's desires), though in most cases, particularly with respect to “connected” apps, server communication will be necessary. If so, the app then sends that information to the App Server in step 232, now enabling the App Server to provide the user with a personalized experience. The app also typically stores that information for future launches of the mobile app, in step 234, whereupon the App Server can now provide the mobile app with a personalized experience without requiring the user to reenter any authenticating information. This process can then be repeated, beginning with step 220, for any of the user's additional mobile devices.

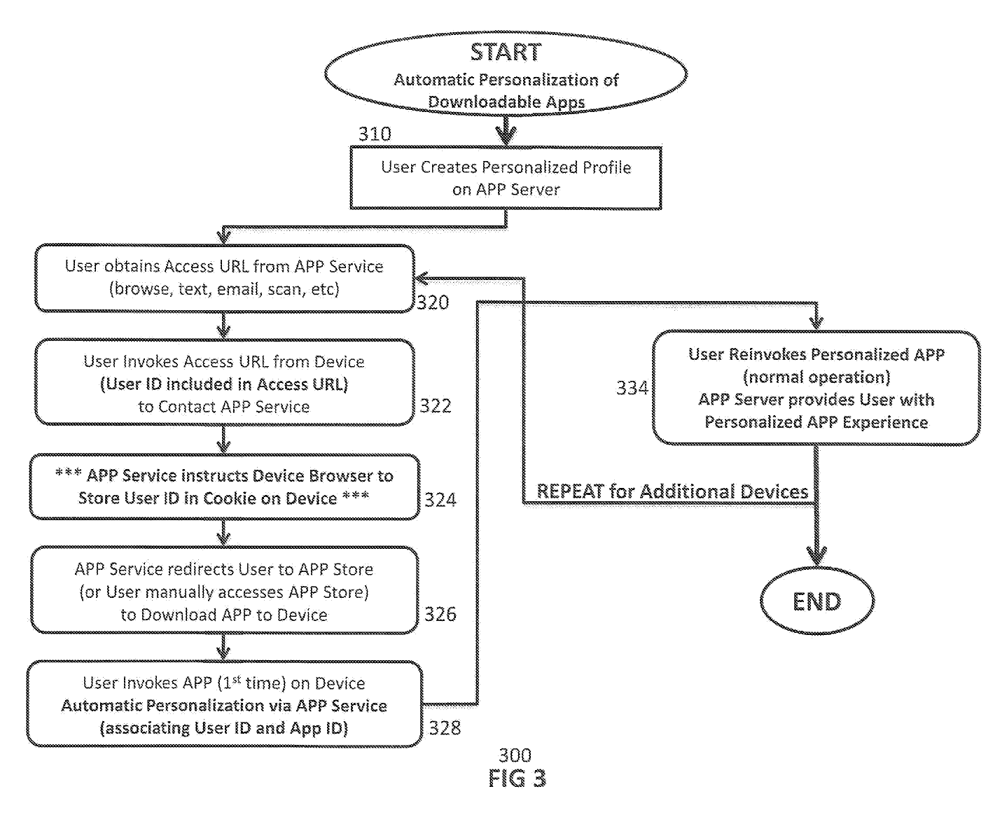

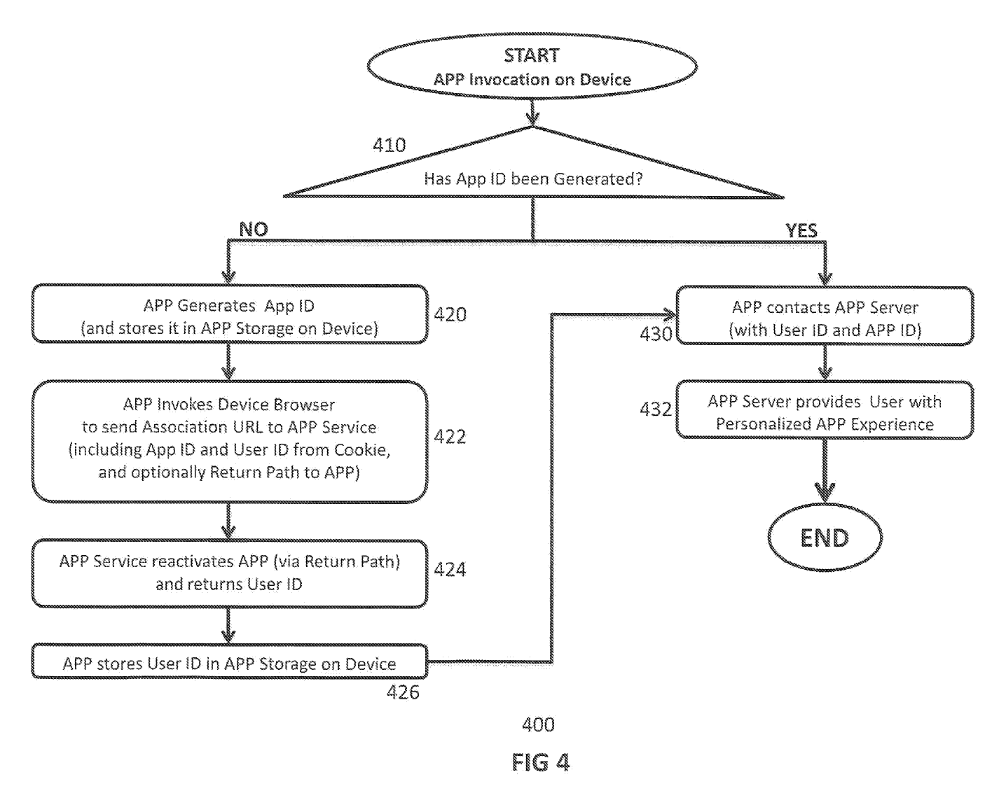

What is apparent from process 200 is that users are required to enter login or other authenticating information whenever they download and initially launch a mobile app that can be personalized. This manual “user-initiated” process will now be contrasted with the automated personalization process of the present invention illustrated in FIGS. 3 and 4.

### C. Automatic App Personalization Process

Turning to FIG. 3, step 310 is similar to step 210 in that the user must somehow create an account and personalized profile (or have one created on the user's behalf) with the provider of mobile app 111. As noted above, users typically perform this process by accessing App Server 120 from their desktop PC (or any desktop or mobile device) via a web browser.

In another embodiment, an intermediary is employed to create the user's account and personalized profile. For example, as discussed above in the context of a residential real estate brokerage, a buyer's agent might create separate accounts for each of his clients, and assign a unique User ID 113 (or “initiation code”) to each client. In any event, App Server 120 must somehow be made aware of User ID 113, which uniquely associates a user (or family or other group of users) with a particular mobile app, such as mobile app 111. Mobile app 111 can then provide a personalized experience to each of the agent's clients, enabling each to see not only information about the agent (e.g., picture, profile description, etc.), but also information about only those homes which the agent has shown or desires to show to that particular client. In this scenario, mobile app 111 is personalized in effect to a pair of users (the agent and each of his clients), rather than to just the user himself. Other combinations of personalized “user groups” of a mobile app are, of course, possible, by extending this concept further (though personalized aspects of mobile app 111 must be designed with such “user groups” in mind).

In one embodiment, App Server 120 then delegates the rest of the download and personalization process to App Service 130, by providing it with the necessary information to identify and contact the user (e.g., a mobile phone number or email address). App Service 130 then generates (or is provided with from App Server 120) User ID 113, which uniquely identifies and associates the user with mobile app 111.

App Server 120 can then wait until it is contacted by mobile app 111 with User ID 113 (and optionally App ID 112, identifying the specific instance of mobile app 111), whereupon it can provide the user with a personalized experience. User ID 113 is, in one embodiment, cryptographically secure, so that it cannot easily be ascertained by any unauthorized personnel. App Server 120 can either maintain User ID 113 directly, or use it as a “key” to its own internal user identification mechanism (e.g., in a custom database record).

In the interim, App Service 130 continues in step 320 to generate an Access URL that not only contains a link to Web Server 130c of App Service 130, but also contains User ID 113. In one embodiment, a “short URL” is generated so that it can easily be sent, for example, via a text message. App Service 130 provides this Access URL (via connection 135) to the user's mobile device (e.g., smartphone 110-1, via connection 115) over the Internet 150. In one embodiment, App Service 130 contacts the user's smartphone 110-1 by sending the Access URL in an email or text message. In other embodiments, the user can enter this information manually, or scan a published “invitation code,” such as a barcode, QR code or other scannable identifier (e.g., using a camera from smartphone 110-1, which then launches Web Browser 110-1c and provides it with the Access URL).

In any event, as a result of step 320, the Access URL is present on smartphone 110-1, and accessible by the user, who clicks on the Access URL in step 322. This invokes Web Browser 110-1c, which in turn contacts Web Server 130c on App Service 130. Web Server 130c then utilizes, in step 324, an existing HTTP “cookie” mechanism to instruct Web Browser 110-1c to store User ID 113 in a cookie on smartphone 110-1, accessible whenever Web Browser 110-1c contacts Web Server 130c with a “matching domain.”

Note that, while this use of a standard HTTP mechanism enables Web Browser 110-1c to access User ID 113, it does not directly provide mobile app 111 with access to User ID 113 (because, as noted above, mobile apps do not generally have access to data stored by other mobile apps on the same device). The subsequent retrieval of User ID 113 by mobile app 111 (necessary to complete the automatic personalization process) will be explained below with respect to FIG. 4.

In the interim, after storing User ID 113 in a cookie on smartphone 110-1, Web Server 130c then proceeds, in step 326, to redirect the user to the appropriate location in the relevant App Store 140-1 from which mobile app 111 can be downloaded to smartphone 110-1. Here too Web Server 130c employs a standard HTTP “redirect” technique to provide to Web Browser 110-1c (and invoke) a “deep link” into App Store 140-1. As a result of this redirection, the user will see the relevant download page within the App Store 140-1, and click on the link to download mobile app 111 to smartphone 110-1, where it will be stored in database 110-1a.

As noted above, standard HTTP “user agent” headers often include sufficient information to enable Web Server 130c to determine the type of the user's mobile device 110-1 (e.g., iPhone v Android) and direct Web Browser 110-1c to the appropriate App Store 140-1. In the event such information is insufficient, Web Server 130c can ask the user to select the appropriate App Store, e.g., by displaying a form with multiple choices from which the user can select.

In any event, after downloading mobile app 111, the user clicks on the app's “icon” in step 328 to launch mobile app 111 for the first time. It is at this point that mobile app 111 must somehow retrieve User ID 113 in order to provide App Server 120 with the sufficient identifying information to be authenticated and personalized. This key step will be discussed in greater detail below with respect to FIG. 4.

Once mobile app 111 is personalized, it can provide User ID 113 (which it stores in its storage area in database 110-1a) to App Server 120, which can then provide the user with a personalized experience (e.g., seeing relevant account profile information, custom data such as a Netflix “instant queue,” etc.). The user can then be provided with this personalized experience upon subsequent relaunches of mobile app 111 (in step 334), and can repeat this automated process (beginning with step 320) for any additional mobile devices.

As noted above, the process for additional mobile devices could be further simplified by employing “cloud” techniques to automatically download mobile app 111 to such devices, invoke Web Browser 110-1c to store User ID 113 in a cookie, and launch mobile app 111 to initiate the automatic personalization process. Such services are not currently available on existing smartphones, but could be added by the provider of mobile device OS 110-1b, leveraging many of the aspects of the present invention.

Turning to FIG. 4, automatic personalization process 400 provides one embodiment of additional detail regarding step 328 (and step 334) of FIG. 3. Whenever the user launches mobile app 111, it first looks (in step 420) at its data storage in database 110-1a to determine whether it is being launched for the first time. In this embodiment, the indicator is the presence of App ID 112, which also serves as a unique identifier of each particular instance of mobile app 111 (e.g., to enable App Server 120 to distinguish among multiple mobile devices utilized by the same user).

If an App ID has been generated previously (i.e., mobile app has already been personalized), then mobile app 110-1 has access in its data storage area of database 110-1a to extract User ID 113 and App ID 112, and provide both to App Server 120 (in step 430), which can then provide the user with a personalized experience in step 432.

In one embodiment, the generation of App ID 112 is optional, in which case the indicator in step 410 can be something else, such as a simple flag indicating whether mobile app 111 has previously been launched. In that case, App Server 120 will be able to determine which user launched mobile app 111 (via User ID 113), but will not be able to distinguish the mobile device from which mobile app 111 was launched. Other non-device-specific aspects of personalization will still, however, be possible.

If no App ID has been generated (and mobile app 111 has not been launched previously), then mobile app 111 will generate an App ID 112 in step 420, and store it in database 110-1a. In another embodiment, mobile app 111 can contact App Service 130 and request that it generate App ID 112. Alternatively, step 420 can be skipped altogether if no App ID 112 is desired (e.g., for more specific personalization).

Turning to step 422, mobile app 111 must now somehow retrieve User ID 113 from database 110-1a. As noted above, it cannot do so directly, as it does not have access to the storage area maintained by Web Browser 110-1c. So, mobile app 111 invokes Web Browser 110-1c and provides it with a portion of the Association URL (i.e., the “matching domain” for Web Server 130c, and optionally App ID 112). Web Browser 110-1c then automatically includes User ID 113 from the cookie (corresponding to this “matching domain”) and contacts Web Server 130c, providing User ID 113 and (optionally) App ID 112.

Note that the same web browser used to store User ID 113 in the cookie (i.e., the default external web browser app, as opposed to a built-in web browser or one provided via an API) must be invoked to provide access to that cookie. In one embodiment, should mobile app 111 be unable to invoke that external default web browser (indicated, for example, by the failure to locate the cookie), then a web page could be displayed requesting the user to click the link representing the Association URL). This will ensure that the external default browser is invoked, and will only require the user to click a link—but still not require the user to enter any login or other authenticating information.

At this point in step 422, User ID 113 must still be made accessible to mobile app 111. So, Web Browser 110-1c must somehow provide a “return path” so that Web Server 130c can reinvoke mobile app 111 and provide it with User ID 113. In an alternative embodiment, App Service 130 provides this information directly (e.g., via server-to-server communication) to App Server 120 (including both User ID 113 and App ID 112).

To reinvoke mobile app 111 (and provide it with User ID 113 as a parameter), another standard HTTP technique is employed. Just as Web Server 130c can instruct Web Browser 110-1c to invoke a particular URL to redirect Web Browser 110-1c to another website (such as the App Store 140-1 “deep link” discussed above), so too can Web Server 130c direct Web Browser 110-1c to launch a completely different application—i.e., mobile app 111 (including User ID 113 as a parameter).

But, mobile app 111 must first configure Web Browser 110-1c with a mechanism to enable mobile app 111 to be invoked by a web server. App Service 130 must be informed of this mechanism, which can be accomplished by receiving “return path” information from App Server 140-1, or including this “return path” information in the Association URL, along with User ID 113 as a parameter.

In one embodiment, this “return path” information is incorporated into the Association URL as data representing a “Content-Type” header containing a MIME type. For example, a unique Content-Type header, specific to mobile app 111 (e.g., “Content-Type: application/MobileApp”), could be included in the Association URL. Web Server 130c could then employ this Content-Type header in its response document back to Web Browser 110-1c (along with User ID 113 as a parameter), causing Web Browser 110-1c to invoke mobile app 111 and provide it with the User ID 113 parameter.

Similarly, a “URL Scheme” technique could be employed. Just as “http:” and “mailto:” are schemes for directing web browsers to take different actions, a custom scheme (e.g., “MobileApp://User ID”) could be inserted into the Association URL, which when redirected by Web Server 130c, would cause Web Browser 110-1c to invoke mobile app 111 and pass provide it with the User ID 113 parameter.

Whether Content-Type headers with MIME types or a custom URL Scheme (or some other mechanism) is employed, App Service 130 (via Web Server 130c) will (in step 424) reinvoke mobile app 111 and provide it with User ID 113 as a parameter. Mobile app 111 then stores User ID 113 in its persistent storage area of database 110-1a (in step 426) and contacts App Server 120 (in step 428) to provide personalization information (i.e., User ID 113 and App ID 112) that enables App Server 120 to provide the user with a personalized experience (including future launches of mobile app 111, as it now has ready access to both User ID 113 and App ID 112 to provide to App Server 120 whenever it is launched). In another embodiment, mobile app 111 could instead store alternative information associating the user with mobile app 111, such as App ID 112, the user's device phone number, etc.

In the event that Web Browser 110-1c does not support redirection to a page that launches an external app, an alternative technique could be employed. For example, a web page could be displayed to the user with a link to click in order to launch mobile app 111. However this reinvocation of mobile app 111 is accomplished, the result is the same: i.e., the automatic personalization of mobile app 111 without requiring the user to enter any login or authenticating information, even upon the initial launch of mobile app 111.

While various embodiments of the present invention have been described herein, many others will be apparent to those skilled in the art, including the extension of these same techniques and apparatus to non-mobile devices, such as televisions, set-top boxes and other devices employing web browsers. Moreover, App Stores and mobile operating systems could be modified to provide for the storage and retrieval of User IDs and/or similar login or authenticating information, thereby enabling mobile apps to be automatically personalized without requiring the user to enter such information.

1. A method for downloading and automatically personalizing an application, the method including the following steps:
(a) invoking a first link on a client device to open a web browser that accesses a web server on a first server device, the first link including a User ID identifying the user of the client device;
(b) receiving the User ID on the web server and instructing the web browser to store a cookie on the client device, wherein the cookie contains the User ID and is accessible by the web browser;
(c) redirecting the web browser to access a second server device and download the application from the second server device onto the client device;
(d) invoking the application for the first time after being downloaded to the client device, wherein the application opens the web browser with a second link, causing the web browser to retrieve the cookie and access the web server on the first server device; and
(e) receiving the cookie on the web server and reinvoking the application on the client device, employing the User ID to provide the user with a personalized experience.
